(19) United States
(12) Patent Application Publication
(10) Pub. No.: US 2014/0188283 A1
(43) Pub. Date: Jul. 3, 2014

(54) ADJUSTING PERFORMANCE RANGE OF COMPUTING DEVICE

(71) Applicants: PROSENJIT GHOSH, Portland, OR (US); KONSTANTIN I. KOULIACHEV, Olympia, WA (US)

(72) Inventors: PROSENJIT GHOSH, Portland, OR (US); KONSTANTIN I. KOULIACHEV, Olympia, WA (US)

(21) Appl. No.: 13/730,322

(22) Filed: Dec. 28, 2012

(51) Int. Cl. G05B 13/02

(52) U.S. Cl. CPC G05B 13/021
USPC 700/275

(57) ABSTRACT

A computing device including an expandable component is described herein. The computing device also includes logic at least a portion of which is in hardware. The logic is to determine a desired performance range for the computing device and expand or compress the expandable component to provide the desired performance range for the computing device.

### TECHNICAL FIELD

One or more embodiments relate generally to adjusting the performance range of a computing device. More specifically, the one or more embodiments relate to a computing device including components that are configured to expand or compress based on a desired performance range.

### BACKGROUND ART

Current computing devices such as ultrathin laptop computers or mobile computing devices are often thermally constrained due to the restricted internal volume of the computing devices. This often limits the usages and capabilities of such computing devices. According to current techniques, the power loading of a computing device may be determined, and then the smallest size or thickness of the computing device may be determined based on the power loading. Alternatively, the geometry, e.g., the size and shape, of the computing device may be determined, and then the amount of power loading that the computing device can handle may be determined based on the geometry of the computing device. As a result, computing devices are often designed as ultrathin systems with limited performance ranges, or as thick and bulky systems with higher performance ranges.

### BRIEF DESCRIPTION OF THE DRAWINGS

FIG. 1 is a block diagram of a computing device that may be used in accordance with embodiments;

FIG. 2 is a schematic of a computing device including expandable components;

FIG. 3 is a generalized process flow diagram showing a method for adjusting a performance range of a computing device;

FIG. 4A is a schematic showing a collapsed mode of a computing device with an expandable chassis that allows for the expansion of the intake and exhaust vents;

FIG. 4B is a schematic showing an expanded mode of the computing device with the expandable chassis;

FIG. 5A is a schematic showing a collapsed mode of another computing device with an expandable chassis that allows for the expansion of the intake and exhaust vents;

FIG. 5B is a schematic showing an expanded mode of the computing device with the expandable chassis;

FIG. 6A is a schematic showing an expandable fan;

FIG. 6B is a schematic showing the internal components of the expandable fan;

FIG. 7A is a schematic showing a compressed mode, an expanded mode, and an internal view of an expandable fan including nested blades;

FIG. 7B is a schematic showing the nested blades of the expandable fan;

FIG. 8A is a schematic showing a compressed mode, an expanded mode, and an internal view of an expandable fan including elastic blades;

FIG. 8B is a schematic showing the elastic blades of the expandable fan;

FIG. 9A is a schematic showing a compressed mode, an expanded mode, and an internal view of an expandable fan including hinged blades;

FIG. 9B is a schematic showing the hinged blades of the expandable fan in an expanded position and a hinged position;

FIG. 10A is a schematic showing a compressed mode of an expandable heat exchanger;

FIG. 10B is a schematic showing an expanded mode of an expandable heat exchanger;

FIG. 11A is a schematic of an expandable heat exchanger including sold interlocking fins;

FIG. 11B is a schematic showing the solid interlocking fins with an interlocking mechanism that includes a small contact patch;

FIG. 11C is a schematic showing the solid interlocking fins with an interlocking mechanism that includes a larger contact patch;

FIG. 12 is a schematic of an expandable heat exchanger including mesh columns;

FIG. 13 is a schematic of an expandable heat exchanger including mesh fins connected across an upper heat pipe and a lower heat pipe of the expandable heat exchanger;

FIG. 14 is a schematic of another expandable heat exchanger including mesh fins connected along an upper heat pipe and a lower heat pipe of the expandable heat exchanger;

FIG. 15 is a schematic of another expandable heat exchanger including mesh fins connected along an upper heat pipe and a lower heat pipe of the expandable heat exchanger at a forty-five degree angle;

FIG. 16 is a schematic of another expandable heat exchanger including mesh fins connected along an upper heat pipe and a lower heat pipe of the expandable heat exchanger at a ninety degree angle;

FIG. 17 is a schematic of an expandable heat exchanger including S-shaped vertical fins;

FIG. 18 is a schematic of an expandable heat exchanger including S-shaped horizontal fins;

FIG. 19 is a schematic of an expandable heat exchanger including a honeycomb material instead of fins;

FIG. 20 is a schematic of an expandable heat exchanger including a flexible oval mesh material instead of fins;

FIG. 21 is a schematic of an expandable heat exchanger including expandable cups instead of fins;

FIG. 22 is a schematic of an expandable heat exchanger including an expandable foil material instead of fins; and

FIG. 23 is a block diagram showing tangible, non-transitory computer-readable media that store code for adjusting a performance range of a computing device.

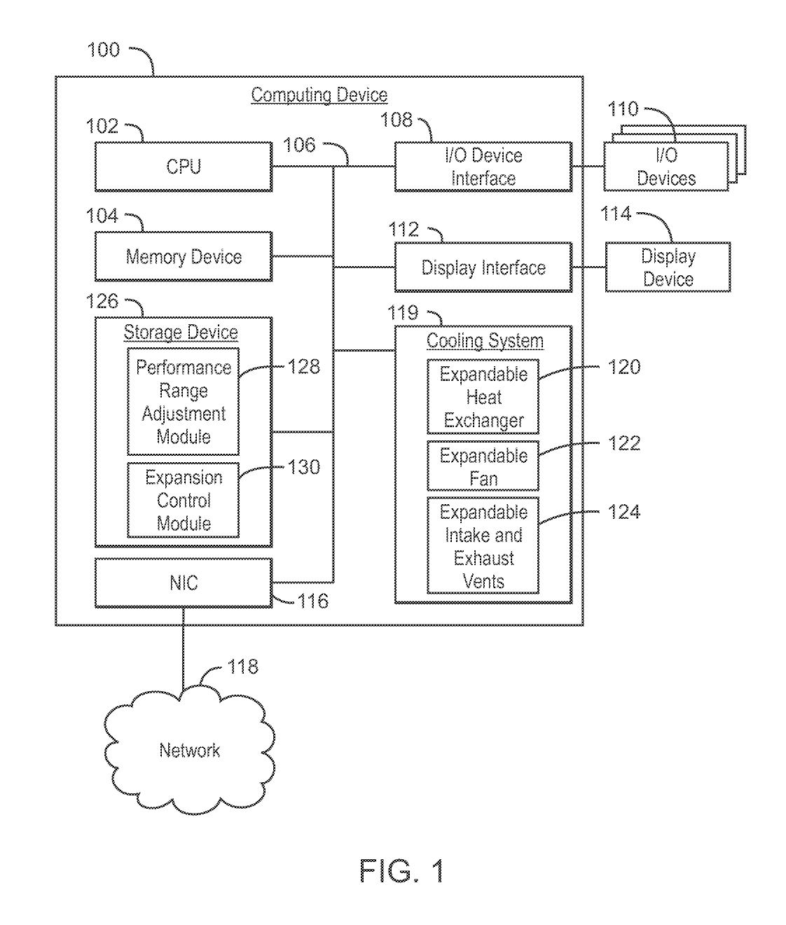

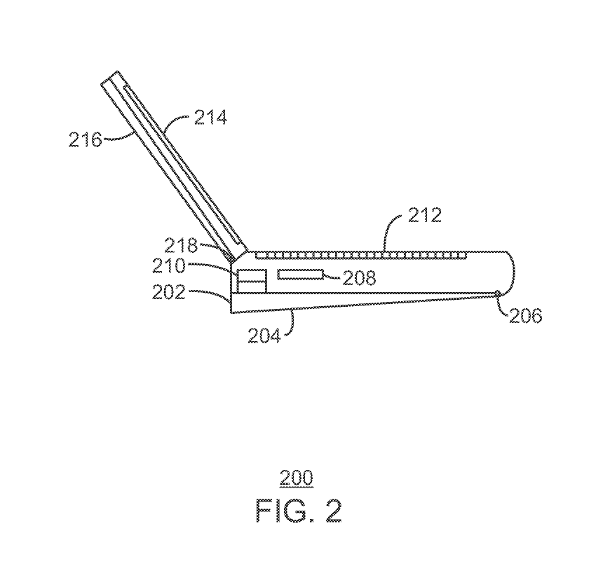

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

As discussed above, current techniques for determining suitable power loading and geometry characteristics of computing devices result in the design of computing devices that are either very thin with limited performance ranges or thick and bulky with higher performance ranges. Accordingly, embodiments described herein provide a computing device including components that are configured to expand or compress based on a desired performance range for the computing device. For example, the computing device described herein may include an expandable heat exchanger, an expandable fan, and expandable intake and exhaust vents. Furthermore, the computing device may also include any number of additional expandable components, such as an expandable keyboard, expandable display device, expandable pointing device, or expandable speakers. The expansion of such components may increase the cooling capacity of the computing device, resulting in a corresponding increase in the performance range of the computing device.

According to embodiments described herein, the expandable components of the computing device may be expanded or compressed according to any number of different techniques based on the details of the specific implementation. Furthermore, the expandable components may be automatically expanded or compressed by the computing device, or may be expanded or compressed in response to input from the user of the computing device, as discussed further below.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments described herein. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a computing device 100 that may be used in accordance with embodiments. The computing device 100 may be a laptop computer, desktop computer, tablet computer, mobile device, server, or any other suitable type of computing device. The computing device 100 may include a central processing unit (CPU) 102 that is configured to execute stored instructions, as well as a memory device 104 that stores instructions that are executable by the CPU 102. The CPU 102 may be coupled to the memory device 104 by a bus 106. Additionally, the CPU 102 can be a single core processor, a multi-core processor, a computing cluster, or any number of other configurations. Furthermore, the computing device 100 may include more than one CPU 102. The instructions that are executed by the CPU 102 may be used to direct the performance range adjustment procedure described herein.

The memory device 104 can include random access memory (RAM), read only memory (ROM), flash memory, or any other suitable memory systems. For example, the memory device 104 may include dynamic random access memory (DRAM).

The CPU 102 may be connected through the bus 106 to an input/output (I/O) device interface 108 configured to connect the computing device 100 to one or more I/O devices 110. The I/O devices 110 may include, for example, a keyboard, speakers, a microphone, and a pointing device, such as a touchpad or touchscreen. The I/O devices 110 may be built-in components of the computing device 100, or may be devices that are externally connected to the computing device 100.

In various embodiments, any of the I/O devices 110 that are built-in components of the computing device 100 may be expandable. For example, if the computing device 100 is a clamshell computing device, such as a laptop computer, the keyboard may vertically expand when the lid of the computing device 100 is opened. In addition, the keys of the keyboard may separate or expand horizontally to increase the pitch of the keyboard. Furthermore, if the pointing device of the computing device 100 is a touchpad or similar technology, it may be also expand during the expansion of the keyboard.

As another example, the speakers of the computing device 100 may move from a compressed position in which the speakers are stored inside the housing, or chassis, of the computing device 100 to an expanded position in which the speakers are located outside the chassis of the computing device 100. For example, a hinge joint connected to each speaker may allow the speaker to expand and slide out of the chassis of the computing device 100 when in use. In various embodiments, the expansion of such I/O devices 110 may increase the cooling capacity of the computing device 100, resulting in a corresponding increase in the computing device's performance range.

The CPU 102 may also be linked through the bus 106 to a display interface 112 configured to connect the computing device 100 to a display device 114. The display device 114 may include a display screen that is a built-in component of the computing device 100. The display device 114 may also include a computer monitor, television, or projector, among others, that is externally connected to the computing device 100. In various embodiments, if the display device 114 is a display screen that is a built-in component of the computing device 100, the display device 114 may be expandable. For example, if the computing device 100 is a clamshell computing device, the display device 114 may expand when the lid of the computing device 100 is opened. The expansion of the display device 114 may also increase the cooling capacity and the performance range of the computing device 100.

The computing device 100 may also include a network interface controller (NIC) 116. The NIC 116 may be configured to connect the computing device 100 through the bus 106 to a network 118. The network 118 may be a wide area network (WAN), local area network (LAN), or the Internet, among others.

The computing device 100 may also include a cooling system 118. The cooling system 118 may include an expandable heat exchanger 120, an expandable fan 122, and expandable intake and exhaust vents 124, as well as any number of other suitable cooling components. According to embodiments described herein, the cooling capacity of the computing device 100 may be varied by expanding or compressing the expandable heat exchanger 120, the expandable fan 122, or the expandable intake and exhaust vents 124, or any combinations thereof. The cooling capacity of the computing device 100 may be varied to achieve a desired performance range for the computing device 100, as discussed further below.

The computing device may also include a storage device 126. The storage device 126 is a physical memory such as a hard drive, an optical drive, a thumbdrive, an array of drives, or any combinations thereof. The storage device 126 may also include remote storage drives. The storage device 126 may include a performance range adjustment module 128 that is configured to determine a desired performance range for the computing device 100. The performance range adjustment module 128 may automatically determine the desired performance range for the computing device 100, or may determine the desired performance range for the computing device 100 in response to input by a user of the computing device 100.

The storage device 126 may also include an expansion control module 130 that is configured to control the expansion or compression of any number of the components of the computing device 100, such as the expandable heat exchanger 120, the expandable fan 122, or the expandable intake and exhaust vents 124, according to the desired performance range. In some embodiments, the expansion control module 130 determines a cooling capacity for a component that corresponds to the desired performance range for the computing device 100, and expands or contracts the component to achieve the determined cooling capacity.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

FIG. 2 is a schematic of a laptop computer 200 including expandable components. In various embodiments, the laptop computer 200 of FIG. 2 is one embodiment of the computing device 100 discussed above with respect to FIG. 1.

The performance range of the laptop computer 200 may be adjusted according to embodiments described herein. Specifically, the performance range of the laptop computer 200 may be adjusted by expanding or compressing any number of expandable components within the laptop computer 200. Moreover, in various embodiments, such expandable components may be used to accommodate for increased power consumption by the laptop computer 200 without impacting the hydraulic resistance of the laptop computer 200.

Expanding the expandable components may increase the cooling capacity of the laptop computer 200, thus resulting in a corresponding increase in the performance range of the laptop computer 200. Alternatively, compressing the expandable components may decrease the cooling capacity of the laptop computer 200, thus resulting in a corresponding decrease in the performance range of the laptop computer 200. Thus, the performance range of the laptop computer 200 may be increased or decreased using the expandable components. For example, the expandable components may be used to increase the power level of the laptop computer 200 from an ultra-low voltage (ULV) power level to a standard voltage (SV) power level, or vice versa. Moreover, the expandable components of the laptop computer 200 may provide for a 90% increase in system cooling as compared to conventional ultrathin laptop computers.

Furthermore, the expansion of the expandable components may provide additional capabilities for the laptop computer 200. For example, the use of additional connectors may be enabled via the expansion of various expandable components within the laptop computer 200. In addition, the ergonomics of the laptop computer 200 may be enhanced via the expansion of various expandable components within the laptop computer 200.

The laptop computer 200 may include expandable intake and exhaust vents 202, as shown in FIG. 2. The size and location of the expandable intake and exhaust vents 202 within the laptop computer 200 may be optimized for the particular layout of the laptop computer 200 to maximize heat exchanger and system power dissipation. In some embodiments, a bottom chassis 204 of the laptop computer 200 is expanded to increase the surface area of the intake and exhaust vents 202. For example, a hinge 206 at the front end of the bottom chassis 204 may allow for the expansion of the intake and exhaust vents 202.

The laptop computer 200 may also include an expandable fan 208 that is configured to vary performance, e.g., air flow and pressure, to accommodate additional power loading. Furthermore, the laptop computer 200 may include an expandable heat exchanger 210 that is configured to accommodate additional power loading without thermally saturating.

In some embodiments, a keyboard 212 of the laptop computer 200 may expand to increase the pitch between the keys or to raise the keyboard to a more ergonomic position. The expansion of the keyboard 212 may also increase the cooling capacity and, thus, the performance range of the laptop computer 200.

Further, in some embodiments, a display device 214 of the laptop computer 200 may expand to increase the cooling capacity and the performance range of the laptop computer 200. Specifically, a display cover 216 of the display device 214, e.g., the lid of the laptop computer 200, may expand from a hinge 216 at the base of the display cover 216.

The schematic of FIG. 2 is not intended to indicate that the laptop computer 200 is to include all of the components shown in FIG. 2. Further, the laptop computer 200 may include any number of additional components not shown in FIG. 2, depending on the details of the specific implementation. The laptop computer 200 may include any number of additional expandable components. For example, any number of different portions of the chassis of the laptop computer 200 may be configured to expand to increase the cooling capacity and the performance range of the laptop computer 200. In addition, the expandable components shown in FIG. 2 may be expanded or compressed via any number of different mechanisms.

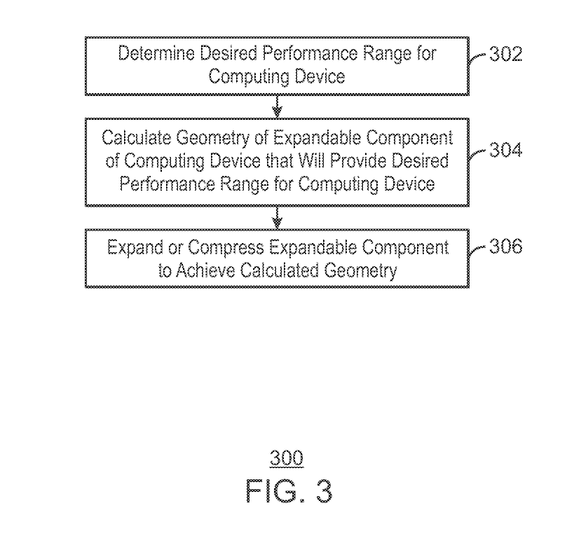

FIG. 3 is a generalized process flow diagram showing a method 300 for adjusting a performance range of a computing device. Specifically, the method 300 may be used to adjust the performance range of any suitable computing device including expandable components, such as the computing device 100 discussed with respect to FIG. 1 or the laptop computer 200 discussed with respect to FIG. 2.

The method begins at block 302, at which a desired performance range for the computing device is determined. In some embodiments, the desired performance range for the computing device is determined automatically by the computing device based on the current operating conditions of the computing device, such as the current power consumption of the computing device. In other embodiments, the desired performance range for the computing device is determined in response to input from a user of the computing device. For example, the user may input a desired performance range for the computing device via a user interface.

At block 304, a geometry of an expandable component of the computing device that will provide the desired performance range for the computing device is determined. More specifically, a geometry of the expandable component that provides a cooling capacity for the computing device that corresponds to the desired performance range is determined.

The expandable component may include an expandable heat exchanger, an expandable air vent, an expandable fan, an expandable keyboard, an expandable display device, expandable speakers, an expandable pointing device, an expandable chassis, or the like. In some embodiments, the expansion of an expandable chassis provides for the exposure of any number of connectors that are not exposed when the expandable chassis is in a compressed position. Furthermore, the method 300 may include determining a geometry of each of a number of expandable components of the computing device that will provide the desired performance range. The computing device may select the expandable components that are to be expanded or compressed such that the computing device achieves a maximum performance range at a minimum overall system volume.

At block 306, the expandable component is expanded or compressed to achieve the calculated geometry. The expansion or compression of the expandable component to the calculated geometry may allow the computing device to operate within the desired performance range.

The process flow diagram of FIG. 3 is not intended to indicate that the blocks of method 300 are to be executed in any particular order, or that all of the blocks are to be included in every case. Further, any number of additional blocks may be included within the method 300, depending on the details of the specific implementation.

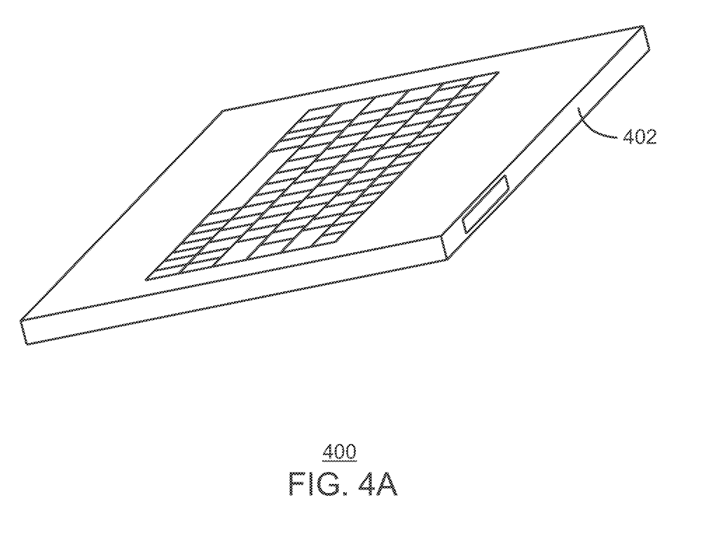

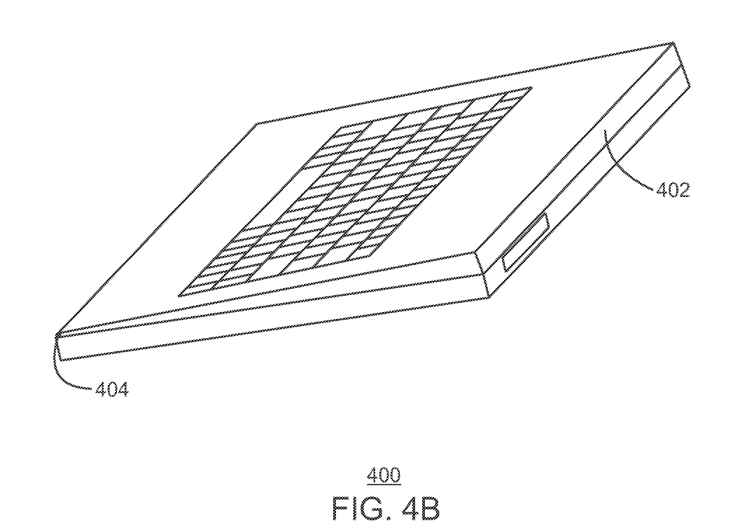

FIG. 4A is a schematic showing a collapsed mode of a computing device 400 with an expandable chassis 402 that allows for the expansion of the intake and exhaust vents. The use of the expandable chassis 402 for the expansion of the intake and exhaust vents may provide for a reduction in the system hydraulic resistance, as well as a reduction in the viscous losses that occur as air passes through the narrow interior space of the computing device 400.

FIG. 4B is a schematic showing an expanded mode of the computing device 400 with the expandable chassis 402. As shown in FIG. 4B, a hinge 404 at the opposite end of the computing device 400 allows for the expansion of the expandable chassis 402. In the expanded mode, the surface area of the expandable chassis 402 is increased, allowing for increased air flow through the intake and exhaust vents.

The schematics of FIGS. 4A and 4B are not intended to indicate that the computing device 400 with the expandable chassis 402 is to include all of the components shown in FIGS. 4A and 4B. Further, the computing device 400 may include any number of additional components not shown in FIGS. 4A and 4B, depending on the details of the specific implementation.

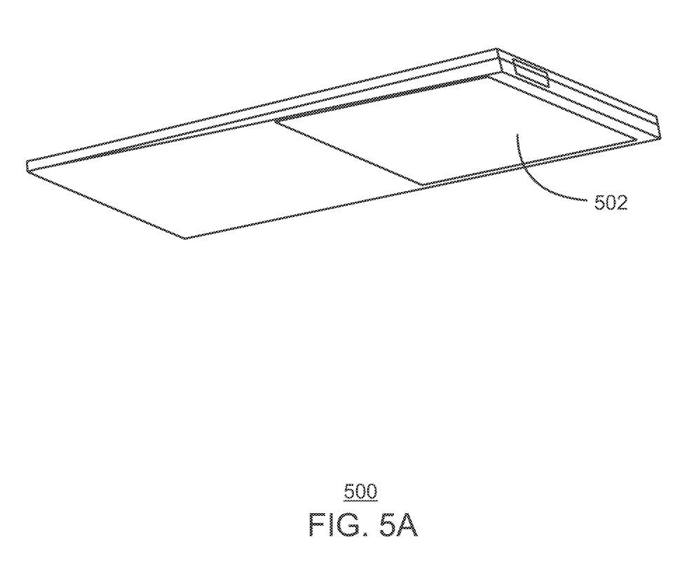

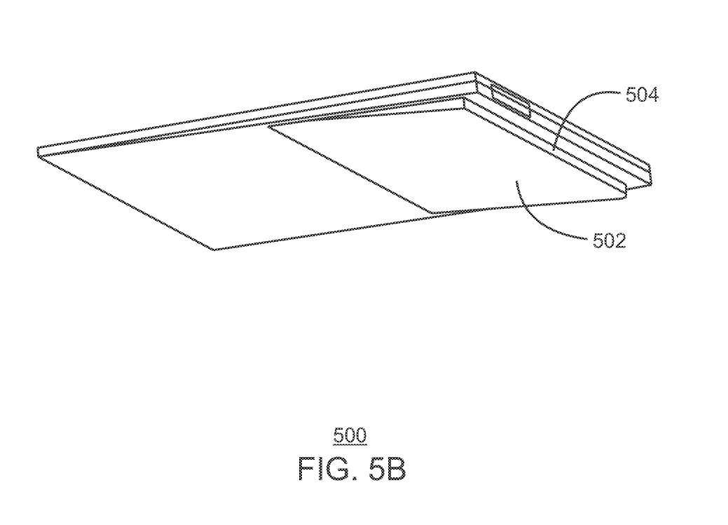

FIG. 5A is a schematic showing a collapsed mode of another computing device 500 with an expandable chassis 502 that allows for the expansion of the intake and exhaust vents. As shown in FIG. 5A, the expandable chassis 502 is located on the bottom of the overall chassis of the computing device 500. The use of the expandable chassis 502 for the expansion of the intake and exhaust vents may provide for a reduction in the system hydraulic resistance, as well as a reduction in the viscous losses that occur as air passes through the narrow interior space of the computing device 500.

FIG. 5B is a schematic showing an expanded mode of the computing device 500 with the expandable chassis 502. In the expanded mode, the surface area of the expandable chassis 502 is increased, resulting in a corresponding increase in the surface area of the intake and exhaust vents 504. Such an increase in the surface area of the intake and exhaust vents 504 allows for increased air flow across the vents 504 and, thus, increases the cooling capacity of the computing device 500.

The schematics of FIGS. 5A and 5B are not intended to indicate that the computing device 500 with the expandable chassis 502 is to include all of the components shown in FIGS. 5A and 5B. Further, the computing device 500 may include any number of additional components not shown in FIGS. 5A and 5B, depending on the details of the specific implementation.

The performance capabilities of fans that are currently being used within computing devices are bound by the physical size of the fans' housing. Specifically, the flow rate of a fan is limited by the fan's blade size, which in turn is limited by the physical limits of the fan's housing. The flow rate of a fan is directly related to the cooling capacity of the computing device in which the fan is implemented. One current technique for increasing a fan's flow rate involves increasing the fan's motor speed. However, increasing the fan's motor speed leads to higher audible noise, which may be unacceptable to the user of the computing device. An alternate technique involves using a larger fan that consumes a larger internal volume within the computing device. However, this technique may result in an increase in the overall size of the computing device.

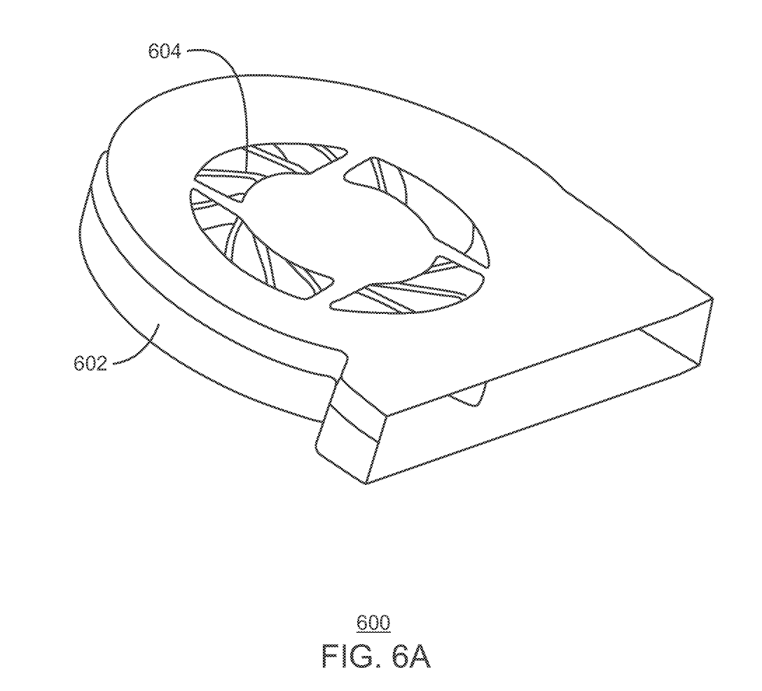

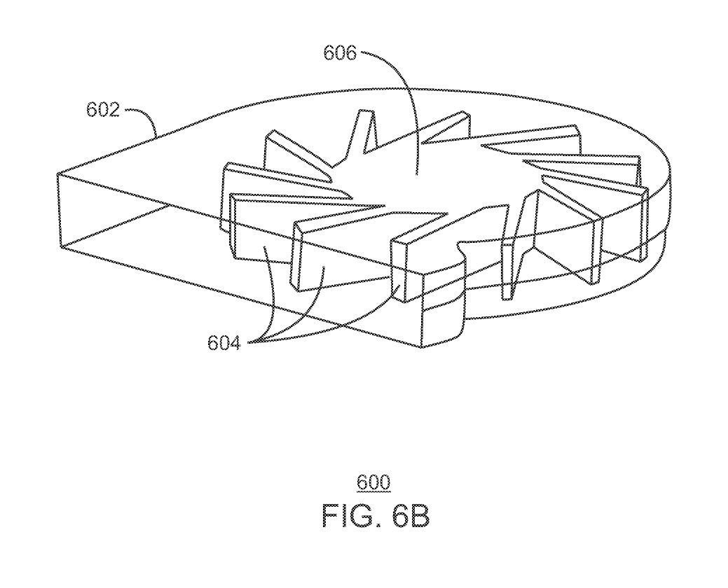

According to embodiments described herein, the flow rate of a fan is increased by physically enlarging the fan for a given computing device design. This may allow for the design of thinner computing devices that can be expanded to increase the thermal headroom and performance without sacrificing other parameters. In various embodiments, the fan may be physically enlarged by increasing the blade size and the housing size of the fan according to any of a variety of different techniques, as discussed further with respect to FIGS. 6-9. Based on the desired increase in the fan's flow rate, the fan's hub and housing may be expanded, allowing the blades to also expand. This may allow increased air flow without sacrificing other parameters, such as static pressure. To accomplish this, the motor of the fan may be modified such that it has sufficient torque to handle the additional blade resistance.

FIG. 6A is a schematic showing an expandable fan 600. In various embodiments, the expansion of the expandable fan 600 provides for a reduction in the hydraulic resistance of the fan 600 by adding more open exhaust areas to the fan 600. As shown in FIG. 6A, the expandable fan 600 includes an expandable housing 602. In addition, the expandable fan 600 includes expandable blades 604, as discussed with respect to FIG. 6B.

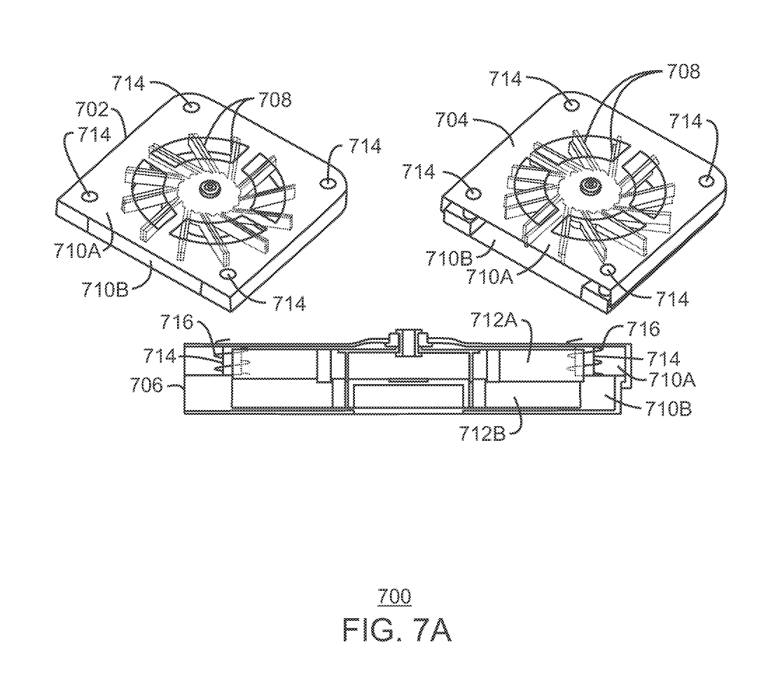

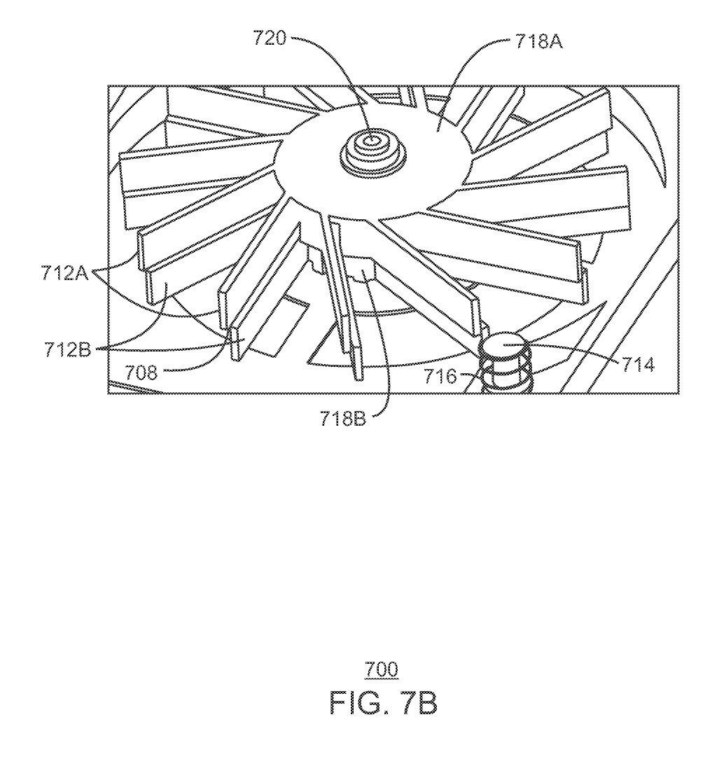

FIG. 6B is a schematic showing the internal components of the expandable fan 600. The expandable fan 600 includes expandable blades 604 connected to a central hub 606. Each of the expandable blades 604 may be configured to expand or compress based on the desired cooling capacity for the expandable fan 600. The mechanism by which the expandable blades 604 expand or compress may vary based on the specific type of expandable fan 600, as discussed further with respect to FIGS. 7-9.

The schematics of FIGS. 6A and 6B are not intended to indicate that the expandable fan 600 is to include all of the components shown in FIGS. 6A and 6B. Further, the expandable fan 600 may include any number of additional components not shown in FIGS. 6A and 6B, depending on the details of the specific implementation.

FIG. 7A is a schematic showing a compressed mode 702, an expanded mode 704, and an internal view 706 of an expandable fan 700 including nested blades 708. The expandable fan 700 may include an upper case half 710A and a lower case half 710B. The upper case half 710A and the lower case half 710B may be composed of sheet metal co-molded with plastic, or simply sheet metal. The nested blades 708 may include two blade arrays 712A and 712B. An upper blade array 712A is anchored to the upper case half 710A, and a lower blade array 712B is anchored to the lower case half 710B.

In addition, an alignment pin 714 may be positioned at each corner of the case halves 710A and 710B. The alignment pins 714 may include springs 716. The springs 716 may be used to bias the assembly open, i.e., in the expanded mode 704.

FIG. 7B is a schematic showing the nested blades 708 of the expandable fan 700. Specifically, the schematic of FIG. 7B shows the two blade arrays 712A and 712B. The two blade arrays 712A and 712B are nested together when the expandable fan 700 is in the compressed mode 702 and are stacked in an offset position when the expandable fan 700 is in the expanded mode 704. In some cases, the two blade arrays 712A and 712B may be partially nested together when the expandable fan 700 is in a partially expanded mode. Furthermore, in some embodiments, the blades of the upper blade array 712A are slightly curved to spring load against the blades of the lower blade array 712B.

The expandable fan 700 may also include an upper hub half 718A and a lower hub half 718B. The upper hub half 718A may be configured to slide vertically relative to the lower hub half 718B. In addition, the two hub halves 718A and 718B may be rotationally keyed using a spline 720.

The schematics of FIGS. 7A and 7B are not intended to indicate that the expandable fan 700 is to include all of the components shown in FIGS. 7A and 7B. Further, the expandable fan 700 may include any number of additional components not shown in FIGS. 7A and 7B, depending on the details of the specific implementation.

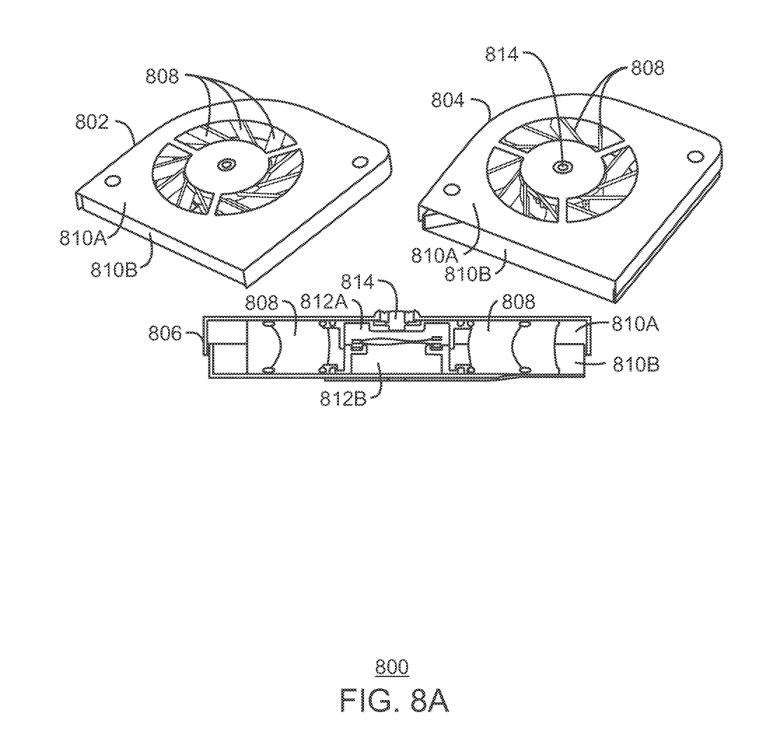

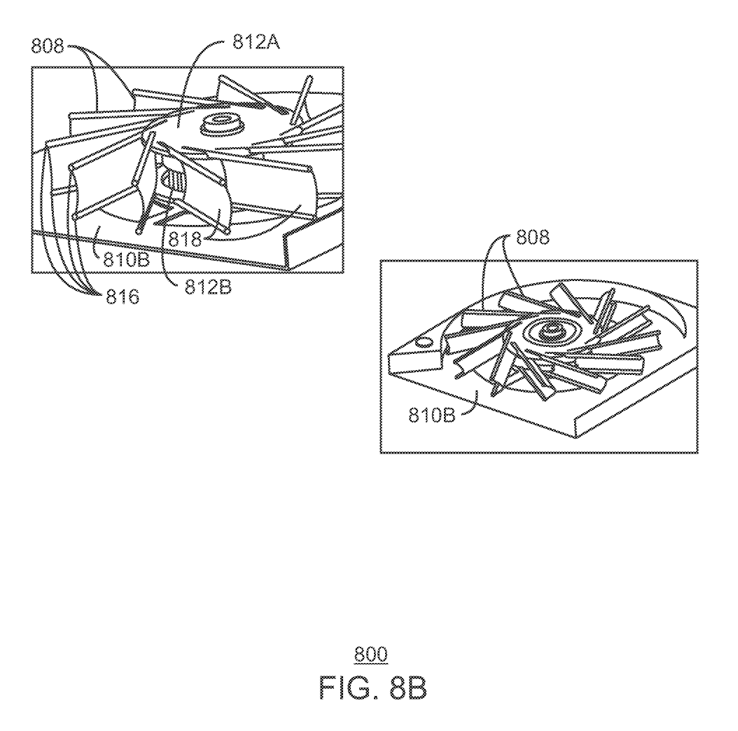

FIG. 8A is a schematic showing a compressed mode 802, an expanded mode 804, and an internal view 806 of an expandable fan 800 including elastic blades 808. The expandable fan 800 may include an upper case half 810A and a lower case half 810B. The upper case half 810A and the lower case half 810B may be composed of sheet metal co-molded with plastic, or simply sheet metal. The expandable fan 800 may also include an upper hub half 812A and a lower hub half 812B. The upper hub half 812A may be configured to slide vertically relative to the lower hub half 812B. In addition, the two hub halves 812A and 7812B may be rotationally keyed using a spline 814.

In various embodiments, the elastic blades 808 of the expandable fan 800 are attached to the upper hub half 812A and the lower hub half 812B. Furthermore, the upper hub half 812A may be spring biased against the upper case half 810A.

FIG. 8B is a schematic showing the elastic blades 808 of the expandable fan 800. Each elastic blade 808 may include rigid spokes 816 on the exterior of the elastic blade 808 and a flexible fan blade 818 in the interior of the elastic blade 808. The rigid spokes 816 may be anchored to the upper and low hub halves 812A and 812B and may define the end connections for the elastic blade 808.

When the expandable fan 800 is in the expanded mode 804, the upper and lower hub halves 812A and 812B may slide vertically apart. The movement of the upper and lower hub halves 812A and 812B causes the rigid spokes 816 of the elastic blades 808 to move apart and the flexible fan blades 818 to straighten into an expanded position.

The schematics of FIGS. 8A and 8B are not intended to indicate that the expandable fan 800 is to include all of the components shown in FIGS. 8A and 8B. Further, the expandable fan 800 may include any number of additional components not shown in FIGS. 8A and 8B, depending on the details of the specific implementation.

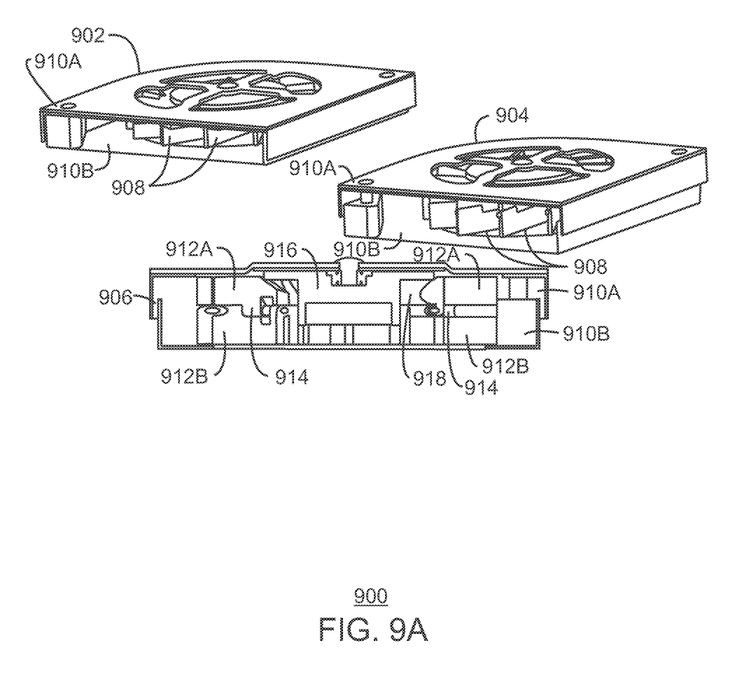

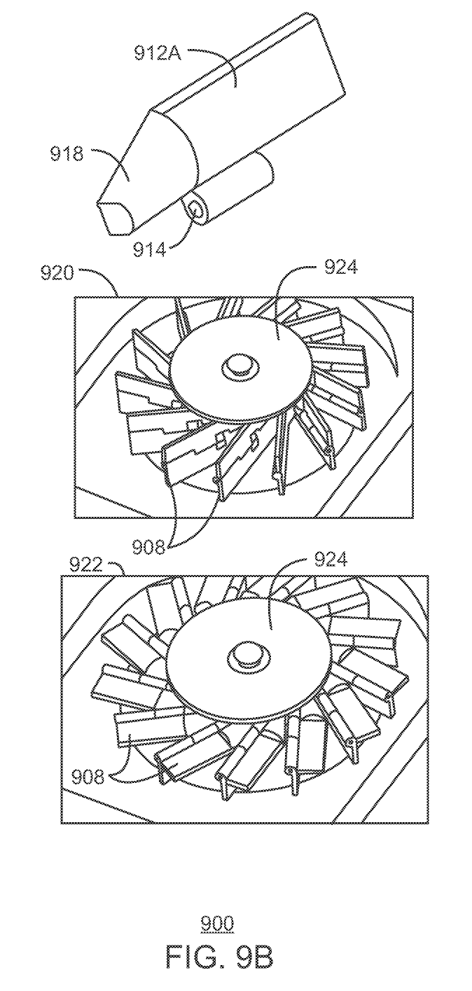

FIG. 9A is a schematic showing a compressed mode 902, an expanded mode 904, and an internal view 906 of an expandable fan 900 including hinged blades 908. The expandable fan 900 may include an upper case half 910A and a lower case half 910B. The upper case half 910A and the lower case half 910B may be composed of sheet metal co-molded with plastic, or simply sheet metal.

Each hinged blade 908 may include an upper blade half 912A and a lower blade half 912B that are connected via a hinge 914 in the middle of the hinged blade 908. When the expandable fan 900 is in the expanded mode 904, the hinged blades 908 may be sprung open by torsion springs. An upper hub 916 within the expandable fan 900 may drive a cam 918 on each hinged blade 908 to control the hinging of the upper and low blade halves 912A and 912B.

FIG. 9B is a schematic showing the hinged blades 908 of the expandable fan 900 in an expanded position 920 and a hinged position 922. A cam plate 924 within the expandable fan 900 rotates with the hinged blades 908 as they are moving to the expanded position 920 or the hinged position 922. Specifically, the vertical motion of the cam plate 924 drives the cams 918 on the hinged blades 908 to open or close the hinges 914 of the hinged blades 908 to the expanded position 920 or the hinged position 922, respectively.

The schematics of FIGS. 9A and 9B are not intended to indicate that the expandable fan 900 is to include all of the components shown in FIGS. 9A and 9B. Further, the expandable fan 900 may include any number of additional components not shown in FIGS. 9A and 9B, depending on the details of the specific implementation.

The size of the heat exchanger within a computing device is directly related to the thermal capabilities, e.g., cooling capacity, of the computing device. Heat exchangers are currently sized based on targeted or worst case thermal design power load. Therefore, for typical application power loads, the heat exchanger is oversized and consumes a large portion of the internal volume of the computing device. In other words, for typical usage conditions, the heat exchanger is not used to capacity. Therefore, it may be desirable to design the heat exchanger of a computing device such that its volume and capacity can be increased or decreased according to the current usage scenario of the computing device.

Accordingly, embodiments described herein provide a heat exchanger that is configured to increase or decrease in volume according the current usage scenario of the computing device. This may result in a decrease in the hydraulic resistance and an increase in the heat transfer capacity of the computing device without increasing the footprint on the computing device layout. This may be accomplished by creating an expandable heat exchanger that may be expanded or compressed according to the desired cooling capacity and performance range for the computing device. The use of such an expandable heat exchanger may enable the design of thinner computing devices with higher performance components.

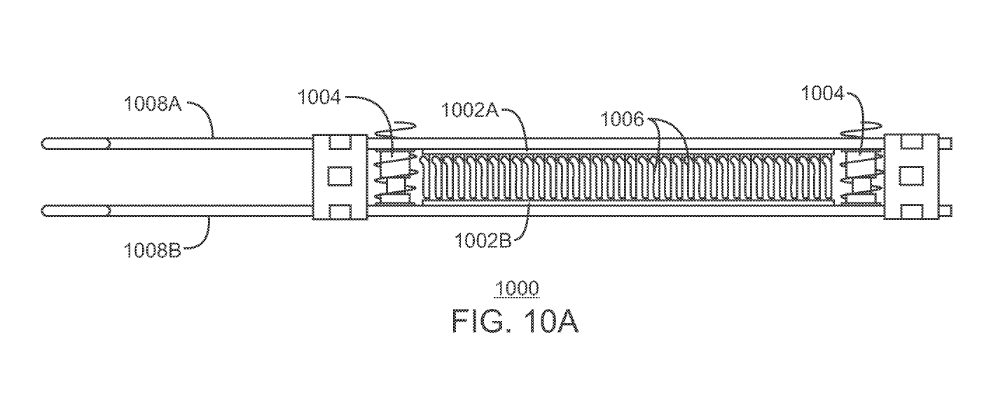

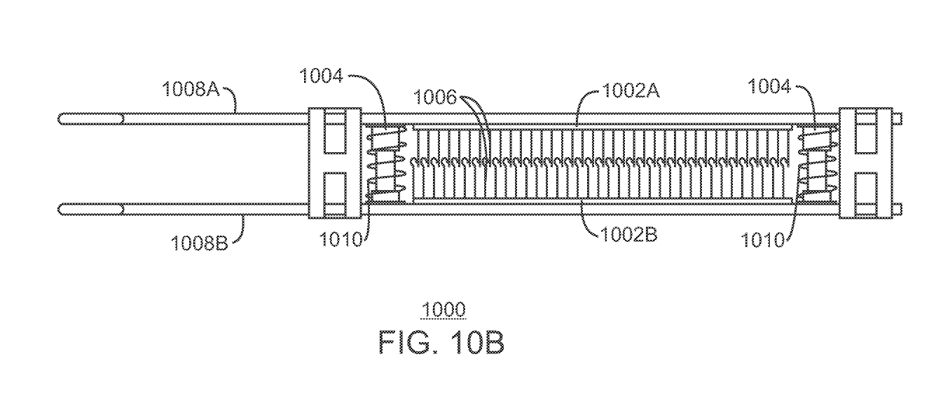

FIG. 10A is a schematic showing a compressed mode of an expandable heat exchanger 1000. The expandable heat exchanger 1000 includes an upper heat exchanger half 1002A and a lower heat exchanger half 1002B. The upper and lower heat exchanger halves 1002A and 1002B are constrained to vertical linear motion by pins 1004.

The upper and lower heat exchanger halves 1002A and 1002B each include a number of fins 1006. The fins 1006 of the two heat exchanger halves 1002A and 1002B are nested, or overlapping, when the expandable heat exchanger 1000 is in the compressed mode. The exact position of the fins 1006, including the fins' pitch and alignment, can be constrained by various methods.

Further, in some embodiments, an upper heat pipe 1008A of the upper heat exchanger half 1002A provides cooling to a particular component, such as a graphics processing unit (GPU) of the computing device. In addition, a lower heat pipe 1008B of the lower heat exchanger half 1002B may provide cooling to a different component, such as the CPU of the computing device.

FIG. 10B is a schematic showing an expanded mode of an expandable heat exchanger 1000. When the expandable heat exchanger 1000 is in the expanded mode, the fins 1006 of the two heat exchanger halves 1002A and 1002B are not overlapping, or are only partially overlapping. The upper heat exchanger half 1002A and the lower heat exchanger half 1002B may be biased in the expanded mode via a spring 1010 on each pin 1004.

In various embodiments, expanding the expandable heat exchanger 1000 reduces its hydraulic resistance, thereby allowing more air or cooling fluid to pass through the computing device. This increases the heat transfer rate, allowing higher power dissipation from components. Coupling this with a variable performance expandable fan may substantially increase the computing device's cooling capabilities.

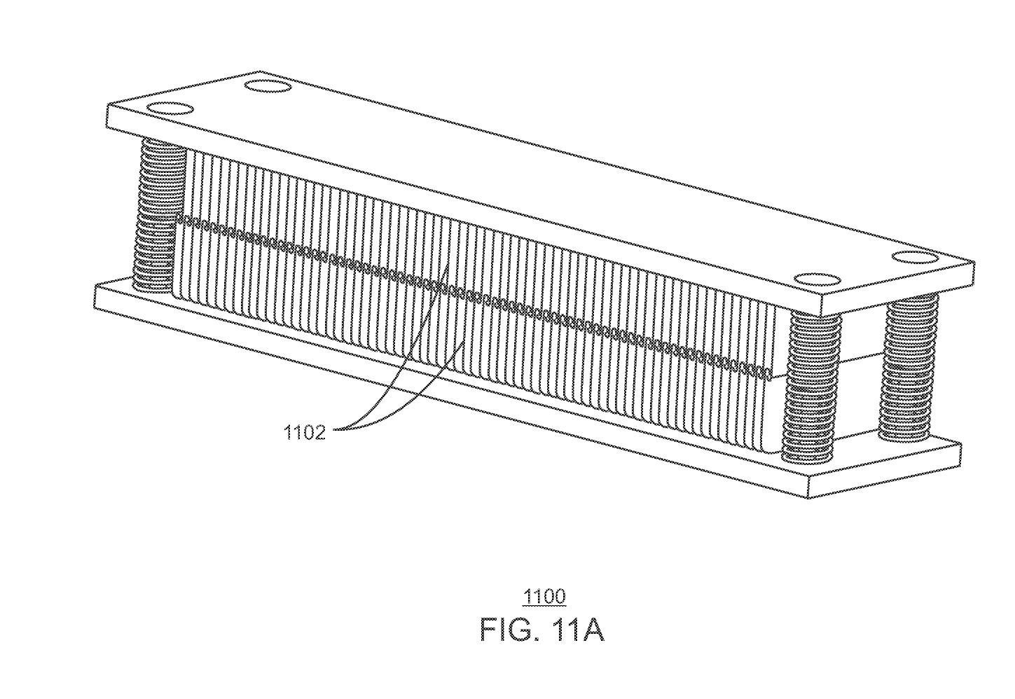

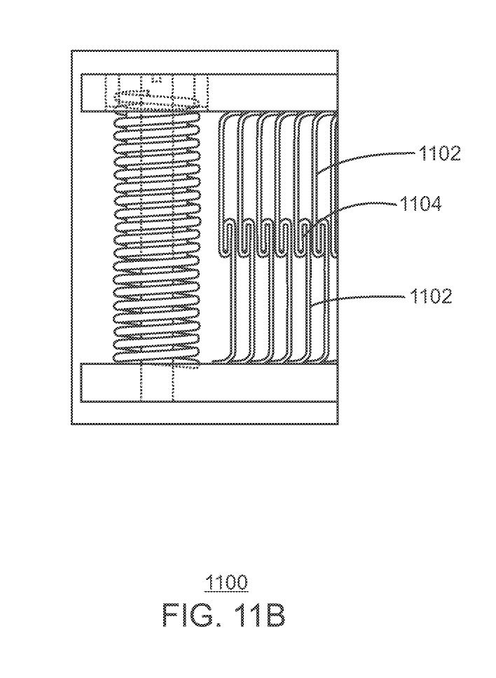

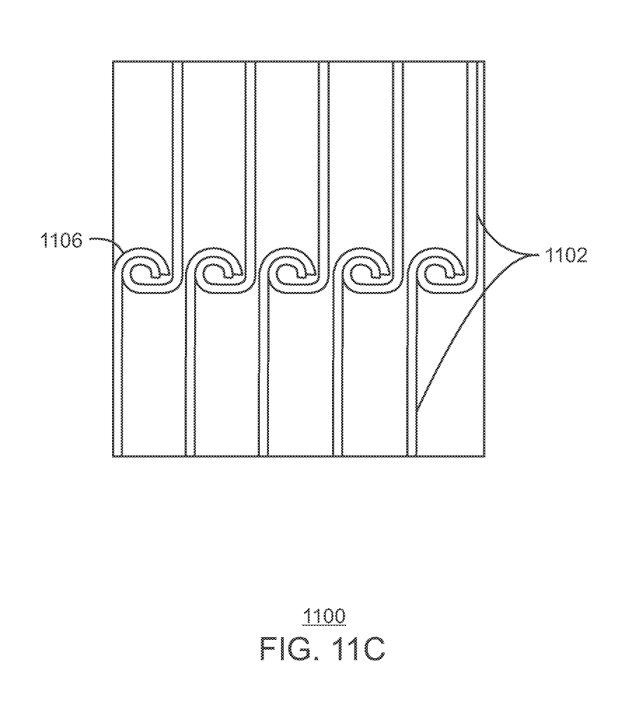

The schematics of FIGS. 10A and 10B are not intended to indicate that the expandable heat exchanger 1000 is to include all of the components shown in FIGS. 10A and 10B. In addition, the expandable heat exchanger 1000 may include any number of additional components not shown in FIGS. 10A and 10B, depending on the details of the specific implementation. For example, various different types of expandable heat exchangers that may be used in place of the heat exchanger 1000, as discussed with respect to FIGS. 11-22.

FIG. 11A is a schematic of an expandable heat exchanger 1100 including sold interlocking fins 1102. The sold interlocking fins 1102 may be interlocked and overlapping when the expandable heat exchanger 1100 is in the compressed mode, and may be interlocked but not overlapping when the expandable heat exchanger 1100 is in the expanded mode.

The mechanism by which the solid interlocking fins 1102 are interlocked with one another may vary depending on the details of the specific implementation. FIG. 11B is a schematic showing the solid interlocking fins 1102 with an interlocking mechanism 1104 that includes a small contact patch. FIG. 11C is a schematic showing the solid interlocking fins 1102 with an interlocking mechanism 1106 that includes a larger contact patch.

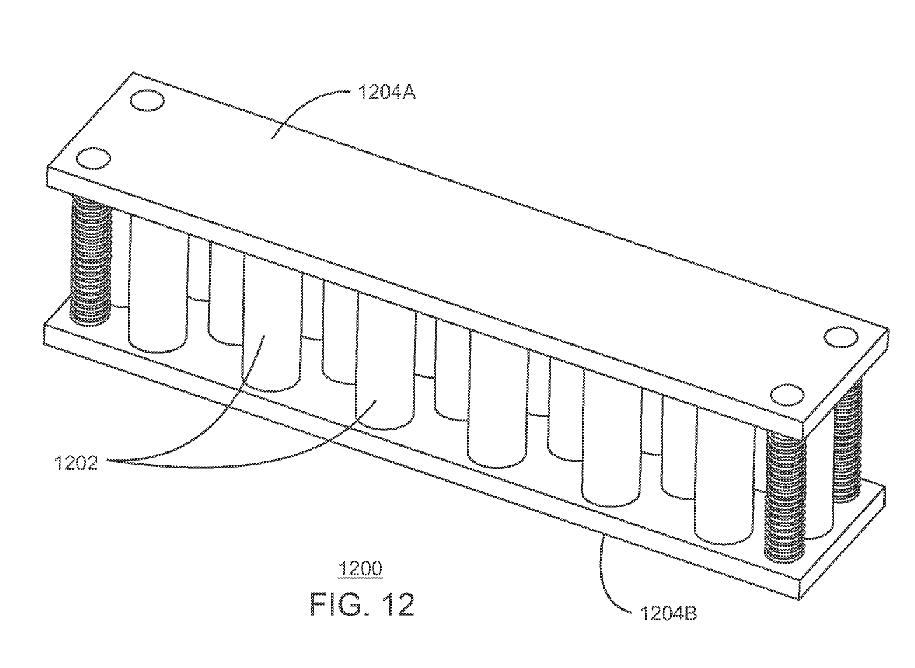

FIG. 12 is a schematic of an expandable heat exchanger 1200 including mesh columns 1202. The mesh columns 1202 may be connected to an upper heat pipe 1204A and a lower heat pipe 1204B of the expandable heat exchanger 1200, and may expand or compress in response to movement of the upper and lower heat pipes 1204A and 1204B.

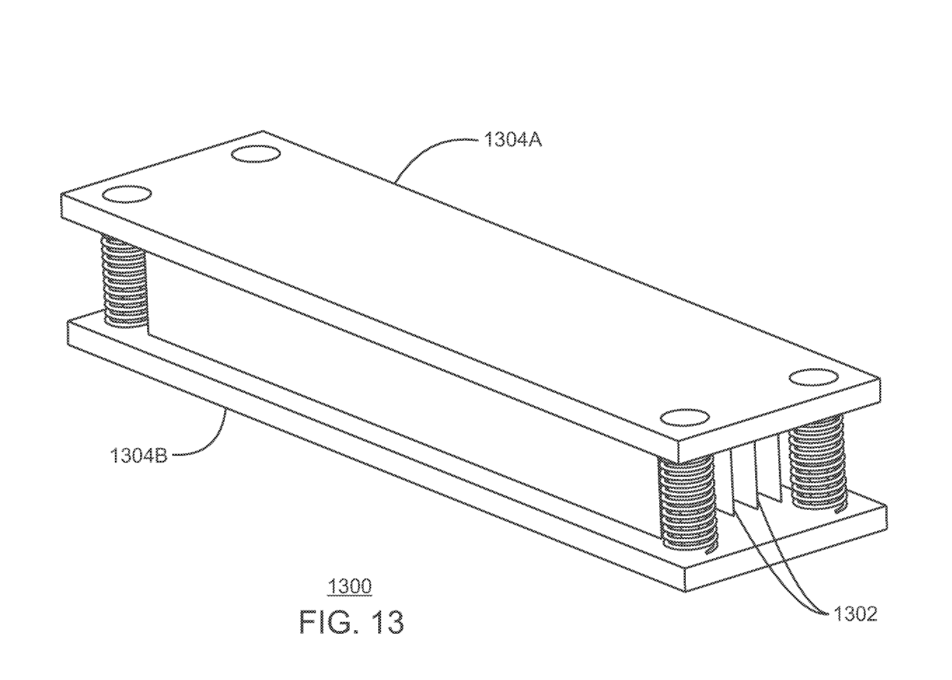

FIG. 13 is a schematic of an expandable heat exchanger 1300 including mesh fins 1302 connected across an upper heat pipe 1304A and a lower heat pipe 1304B of the expandable heat exchanger 1300. The mesh fins 1302 may expand or compress in response to movement of the upper and lower heat pipes 1304A and 1304B.

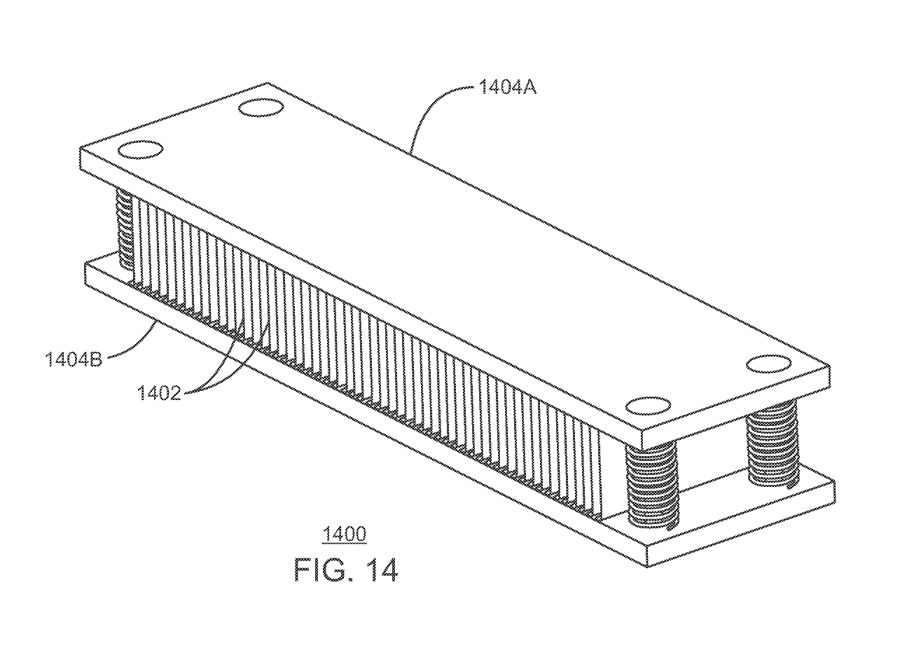

FIG. 14 is a schematic of another expandable heat exchanger 1400 including mesh fins 1402 connected along an upper heat pipe 1404A and a lower heat pipe 1404B of the expandable heat exchanger 1400. The mesh fins 1402 may expand or compress in response to movement of the upper and lower heat pipes 1404A and 1404B.

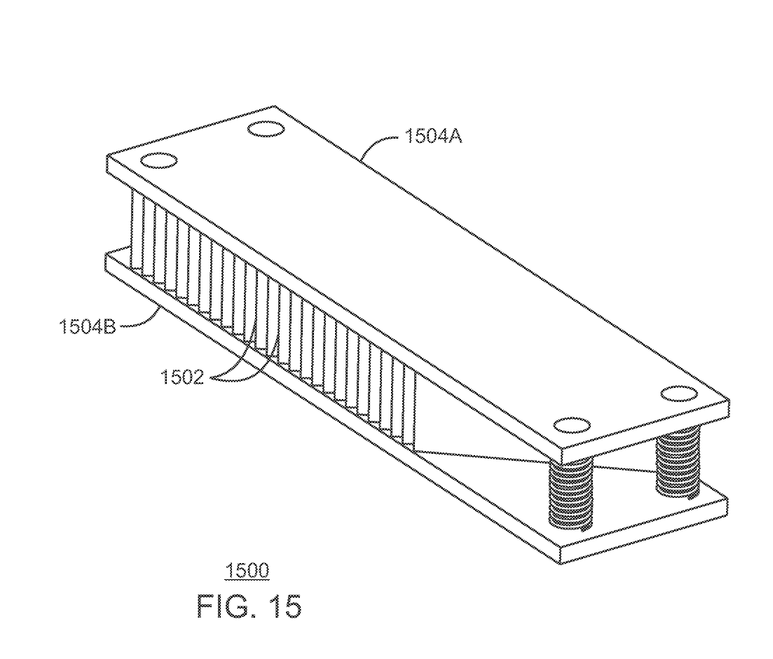

FIG. 15 is a schematic of another expandable heat exchanger 1500 including mesh fins 1502 connected along an upper heat pipe 1504A and a lower heat pipe 1504B of the expandable heat exchanger 1500 at a forty-five degree angle. The mesh fins 1502 may expand or compress in response to movement of the upper and lower heat pipes 1504A and 1504B.

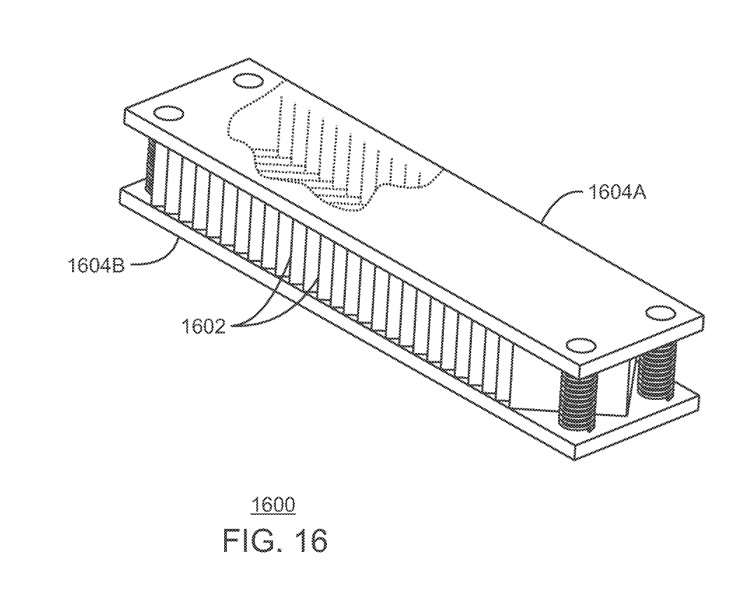

FIG. 16 is a schematic of another expandable heat exchanger 1600 including mesh fins 1602 connected along an upper heat pipe 1604A and a lower heat pipe 1604B of the expandable heat exchanger 1600 at a ninety degree angle. The mesh fins 1602 may expand or compress in response to movement of the upper and lower heat pipes 1604A and 1604B.

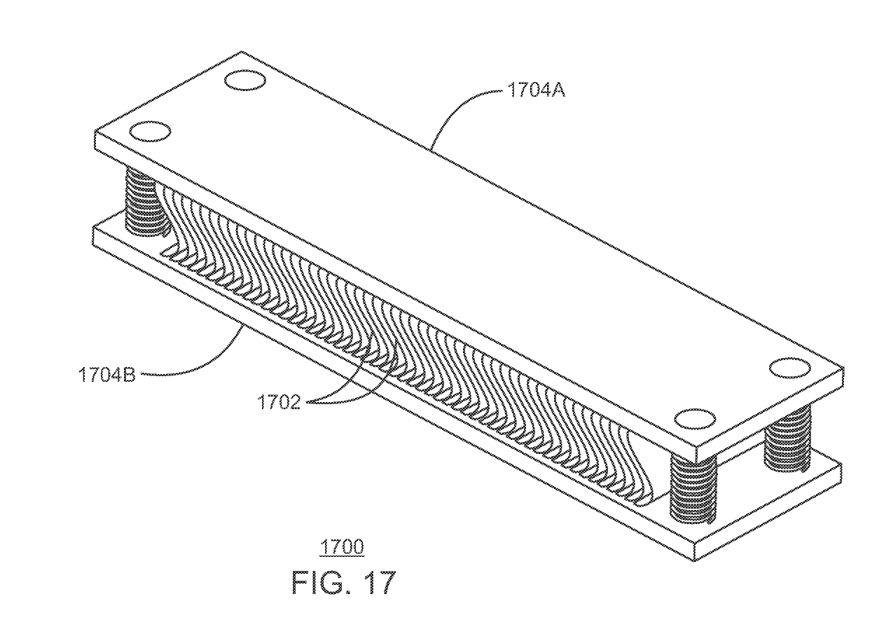

FIG. 17 is a schematic of an expandable heat exchanger 1700 including S-shaped vertical fins 1702. The S-shaped vertical fins 1702 may be composed of either mesh or solid material. The S-shaped vertical fins 1702 may be connected to an upper heat pipe 1704A and a lower heat pipe 1704B of the expandable heat exchanger 1700, and may expand or compress in response to movement of the upper and lower heat pipes 1704A and 1704B.

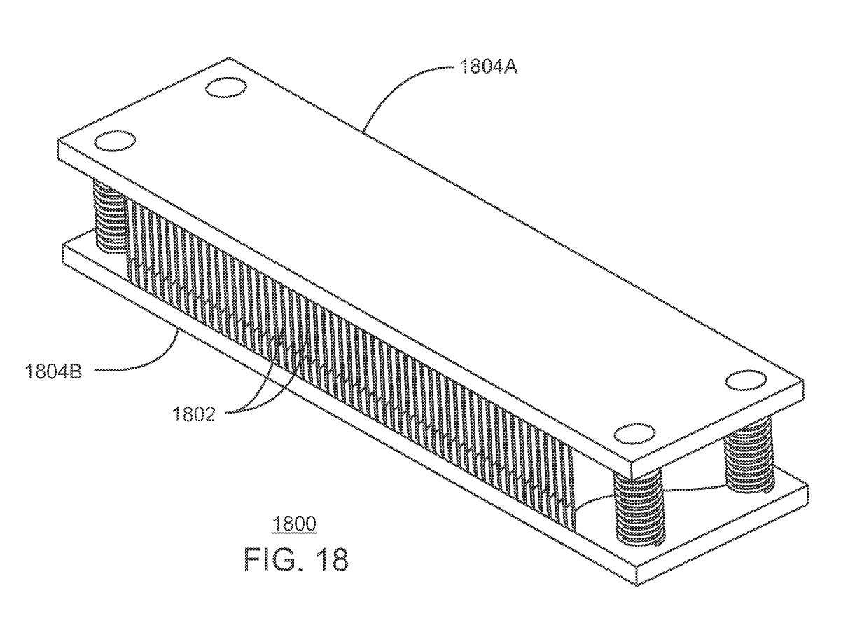

FIG. 18 is a schematic of an expandable heat exchanger 1800 including S-shaped horizontal fins 1802. The S-shaped horizontal fins 1802 may be composed of either mesh or solid material. The S-shaped horizontal fins 1802 may be connected to an upper heat pipe 1804A and a lower heat pipe 1804B of the expandable heat exchanger 1800, and may expand or compress in response to movement of the upper and lower heat pipes 1804A and 1804B.

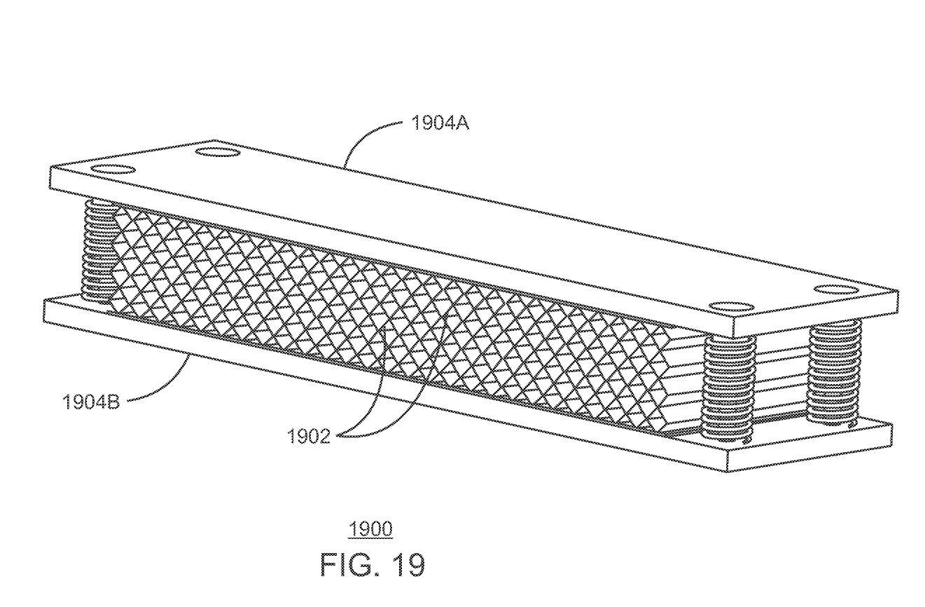

FIG. 19 is a schematic of an expandable heat exchanger 1900 including a honeycomb material 1902 instead of fins. The honeycomb material 1902 may be connected to an upper heat pipe 1904A and a lower heat pipe 1904B of the expandable heat exchanger 1900, and may expand or compress in response to movement of the upper and lower heat pipes 1904A and 1904B.

In various embodiments, the honeycomb material 1902 includes individual corrugated sheet springs that are soldered together. In addition, metal plates may be soldered to the crests of the top and bottom sheet springs within the honeycomb material 1902. The metal plates may be in sliding contact with the upper and lower heat pipes 1904A and 1904B.

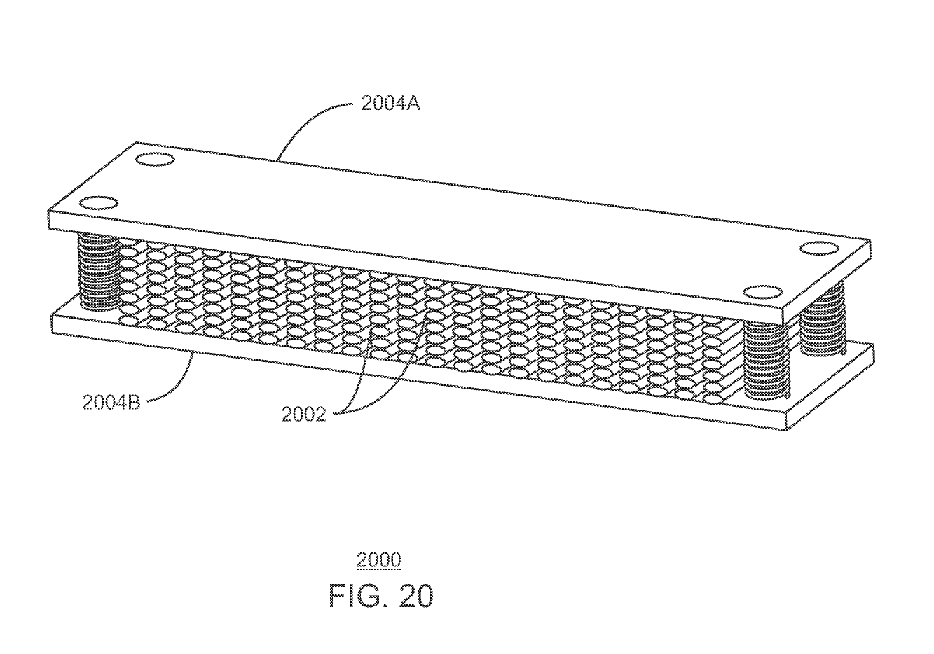

FIG. 20 is a schematic of an expandable heat exchanger 2000 including a flexible oval mesh material 2002 instead of fins. The flexible oval mesh material 2002 may be connected to an upper heat pipe 2004A and a lower heat pipe 2004B of the expandable heat exchanger 2000, and may expand or compress in response to movement of the upper and lower heat pipes 2004A and 2004B.

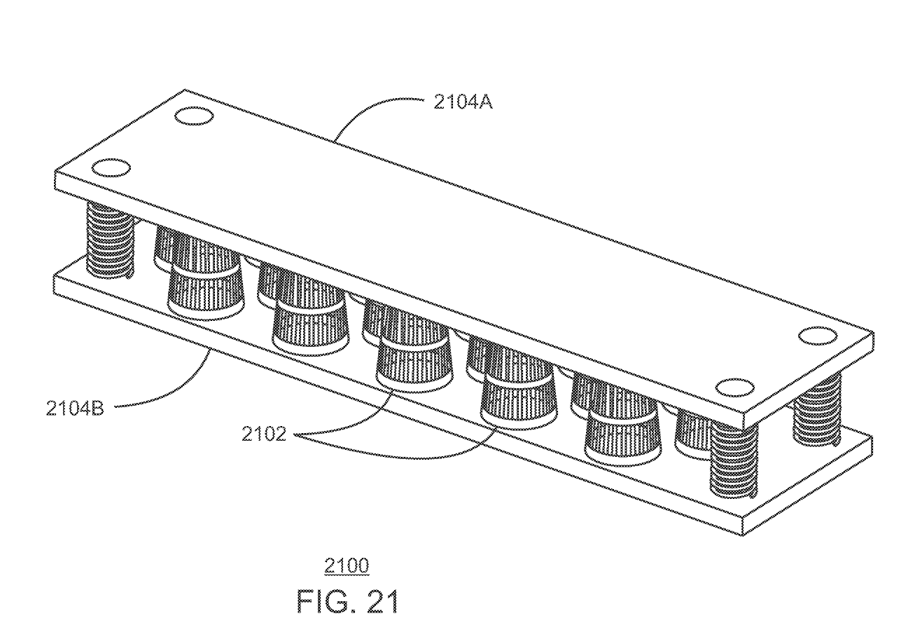

FIG. 21 is a schematic of an expandable heat exchanger 2100 including expandable cups 2102 instead of fins. The expandable cups 1202 may be connected to an upper heat pipe 2104A and a lower heat pipe 2104B of the expandable heat exchanger 2100, and may expand or compress in response to movement of the upper and lower heat pipes 2104A and 2104B.

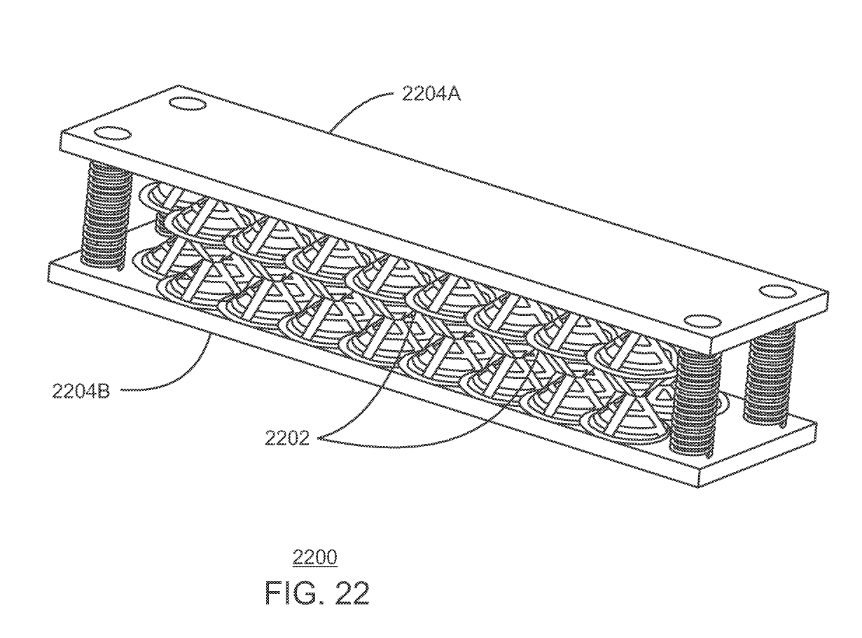

FIG. 22 is a schematic of an expandable heat exchanger 2200 including an expandable foil material 2202 instead of fins. The expandable foil material 2202 may be connected to an upper heat pipe 2204A and a lower heat pipe 2204B of the expandable heat exchanger 2200, and may expand or compress in response to movement of the upper and lower heat pipes 2204A and 2204B.

The schematics of the FIGS. 11-22 are not intended to indicate that the expandable heat exchangers 1100-2200 are to include all of the components shown in the corresponding FIGS. 11-22. In addition, the expandable heat exchangers 1100-2200 may include any number of additional components not shown in the corresponding FIGS. 11-22, depending on the details of the specific implementation. For example, in some embodiments, each expandable heat exchanger 1100-2200 may be designed to accommodate a single heat source, which can be attached to one side of the expandable heat exchanger 1100-2200. In other embodiments, each expandable heat exchanger 1100-2200 may be designed to accommodate a dual heat source, which can be attached to the top and bottom sides of the expandable heat exchanger 1100-2200.

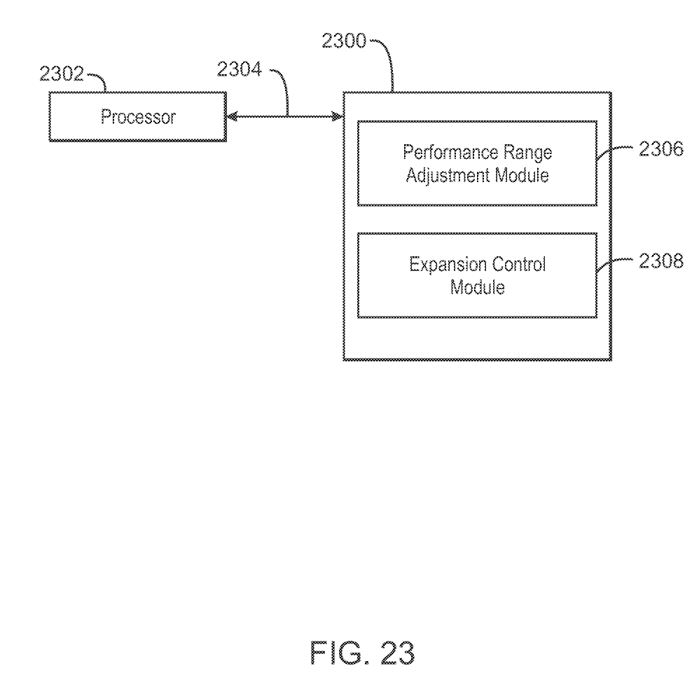

FIG. 23 is a block diagram showing tangible, non-transitory computer-readable media 2300 that store code for adjusting a performance range of a computing device. The tangible, non-transitory computer-readable media 2300 may be accessed by a processor 2302 over a computer bus 2304. Furthermore, the tangible, non-transitory computer-readable media 2300 may include code configured to direct the processor 2302 to perform the techniques described herein.

The various software components discussed herein may be stored on the tangible, non-transitory computer-readable media 2300, as indicated in FIG. 23. For example, a performance range adjustment module 2306 may be configured to determine appropriate adjustments to the performance range of a computing device. In addition, an expansion control module 2308 may be configured to control the expansion or compression of any number of components of the computing device according to the determined performance range adjustments.

The block diagram of FIG. 23 is not intended to indicate that the tangible, non-transitory computer-readable media 2300 are to include all of the components shown in FIG. 23. Further, the tangible, non-transitory computer-readable media 2300 may include any number of additional components not shown in FIG. 23, depending on the details of the specific implementation.

### Example 1

A computing device is described herein. The computing device includes an expandable component. The computing device also includes logic at least a portion of which is in hardware. The logic is to determine a desired performance range for the computing device and expand or compress the expandable component to provide the desired performance range for the computing device.

The expandable component may include nested heat exchangers, and the logic may expand the nested heat exchangers by separating a number of fins of a first one of the nested heat exchangers from a number of fins of a second one of the nested heat exchangers via vertical linear motion. The expandable component may also include an expandable fan, and the logic may expand the expandable fan by increasing a size of a number of blades and a housing of the expandable fan.

The expandable component may include an expandable air vent, and the logic may expand the expandable air vent by increasing a size of the expandable air vent by increasing a size of a chassis of the computing device. The expandable component may include an expandable display device, and the logic may expand the expandable display device by increasing a size of a display cover of the expandable display device. In addition, the expandable component may include expandable speakers, and the logic may expand the expandable speakers by moving the expandable speakers from a compressed position in which the expandable speakers are stored inside a chassis of the computing device to an expanded position in which the expandable speakers are located outside the chassis of the computing device.

The expandable component may include an expandable chassis, and the logic may expand the expandable chassis by increasing a size of a portion of the expandable chassis. The expansion of the expandable chassis may provide for an exposure of a connector that is not exposed when the expandable chassis is compressed. The computing device may include a number of expandable components, and wherein the logic may determine a desired performance range for the computing device and expand or compress each expandable component to achieve the determined performance range.

The expandable component may include an expandable heat exchanger. The expandable heat exchanger may include a number of nested fins, and the nested fins may be at least partially separated when the expandable heat exchanger is expanded. The expandable heat exchanger may include a number of solid interlocking fins, and the solid interlocking fins may be at least partially separated when the expandable heat exchanger is expanded. The expandable heat exchanger may include a number of mesh columns coupled to an upper heat pipe and a lower heat pipe of the expandable heat exchanger, and the mesh columns may be expanded or compressed in response to a movement of the upper heat pipe or the lower heat pipe, or both.

The expandable heat exchanger may include a number of mesh fins coupled to an upper heat pipe and a lower heat pipe of the expandable heat exchanger, and the mesh fins may be expanded or compressed in response to a movement of the upper heat pipe or the lower heat pipe, or both. The expandable heat exchanger may include a honeycomb material coupled to an upper heat pipe and a lower heat pipe of the expandable heat exchanger, and the honeycomb material may be expanded or compressed in response to a movement of the upper heat pipe or the lower heat pipe, or both. The expandable heat exchanger may include a number of expandable cups coupled to an upper heat pipe and a lower heat pipe of the expandable heat exchanger, and the expandable cups may be expanded or compressed in response to a movement of the upper heat pipe or the lower heat pipe, or both.

The expandable component may include an expandable fan that is configured to expand by increasing a size of a number of blades of the expandable fan. The blades may include nested blades, elastic blades, or hinged blades, or any combination thereof.

The expandable component may also include an expandable vent. The expandable vent may be expanded by increasing a surface area of a portion of a chassis of the computing device on which the expandable vent is positioned. Furthermore, the expandable component may include an expandable keyboard, an expandable display device, expandable speakers, or an expandable pointing device, or any combinations thereof.

The logic may determine the desired performance range for the computing device in response to input from a user of the computing device. Alternatively, the logic may automatically determine the desired performance range for the computing device based on operating conditions of the computing device.

The logic may determine a cooling capacity for the computing device that corresponds to the desired performance range and expand or compress the expandable component to provide the determined cooling capacity for the computing device. The logic may determine a geometry of the expandable component that will provide the desired performance range for the computing device and expand or compress the expandable component to achieve the determined geometry.

### Example 2

At least one machine readable medium is described herein. The at least one machine readable medium has instructions stored therein that, in response to being executed on a computing device, cause the computing device to determine a desired performance range for the computing device. The instructions also cause the computing device to expand or compress an expandable component of the computing device to achieve the determined geometry.

The instructions may cause the computing device to determine a cooling capacity for the computing device that corresponds to the desired performance range and expand or compress the expandable component to provide the determined cooling capacity for the computing device. The instructions may also cause the computing device determine a geometry of the expandable component that will provide the desired performance range for the computing device and expand or compress the expandable component to achieve the determined geometry.

The instructions may cause the computing device to determine the desired performance range for the computing device in response to input from a user of the computing device. Alternatively, the instructions may cause the computing device to determine the desired performance range for the computing device automatically based on operating conditions of the computing device.

### Example 3

A computing device is described herein. The computing device includes an expandable component and a processor that is configured to execute stored instructions. The computing device also includes a storage device that stores instructions. The storage device includes processor executable code that, when executed by the processor, is configured to determine a desired performance range for the computing device, determine a geometry of the expandable component that will provide the desired performance range for the computing device, and expand or compress the expandable component to achieve the determined geometry.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the embodiments are not limited to those diagrams or to corresponding descriptions herein. For example, flow need not move through each illustrated box or state or in exactly the same order as illustrated and described herein.

Embodiments described herein are not restricted to the particular details listed herein. Indeed, those skilled in the art having the benefit of this disclosure will appreciate that many other variations from the foregoing description and drawings may be made within the scope of the present embodiments. Accordingly, it is the following claims including any amendments thereto that define the scope of the embodiments.

What is claimed is:

1. A computing device, comprising:
an expandable component; and
logic at least a portion of which is in hardware, the logic to:
determine a desired performance range for the computing device; and
expand or compress the expandable component to provide the desired performance range for the computing device.

2. The computing device of claim 1, wherein the expandable component comprises nested heat exchangers, and wherein the logic is to expand the nested heat exchangers by separating a plurality of fins of a first one of the nested heat exchangers from a plurality of fins of a second one of the nested heat exchangers via vertical linear motion.

3. The computing device of claim 1, wherein the expandable component comprises an expandable air vent, and wherein the logic is to expand the expandable air vent by increasing a size of the expandable air vent by increasing a size of a chassis of the computing device.

4. The computing device of claim 1, wherein the expandable component comprises an expandable display device, and wherein the logic is to expand the expandable display device by increasing a size of a display cover of the expandable display device.

5. The computing device of claim 1, wherein the expandable component comprises expandable speakers, and wherein the logic is to expand the expandable speakers by moving the expandable speakers from a compressed position in which the expandable speakers are stored inside a chassis of the computing device to an expanded position in which the expandable speakers are located at least partially outside the chassis of the computing device.

6. The computing device of claim 1, wherein the expandable component comprises an expandable chassis, and the logic is to expand the expandable chassis by increasing a size of a portion of the expandable chassis.

7. The computing device of claim 6, wherein the expansion of the expandable chassis provides for an exposure of a connector that is not exposed when the expandable chassis is compressed.

8. The computing device of claim 1, wherein the computing device comprises a plurality of expandable components, and wherein the logic is to determine a desired performance range for the computing device and expand or compress each of the plurality of expandable components to achieve the determined performance range.

9. The computing device of claim 1, wherein the expandable component comprises an expandable heat exchanger.

10. The computing device of claim 9, wherein the expandable heat exchanger comprises a plurality of nested fins, and wherein the plurality of nested fins are at least partially separated when the expandable heat exchanger is expanded.

11. The computing device of claim 9, wherein the expandable heat exchanger comprises a plurality of solid interlocking fins, and wherein the plurality of solid interlocking fins are at least partially separated when the expandable heat exchanger is expanded.

12. The computing device of claim 9, wherein the expandable heat exchanger comprises a plurality of mesh columns coupled to an upper heat pipe and a lower heat pipe of the expandable heat exchanger, and wherein the plurality of mesh columns are expanded or compressed in response to a movement of the upper heat pipe or the lower heat pipe, or both.

13. The computing device of claim 9, wherein the expandable heat exchanger comprises a plurality of mesh fins coupled to an upper heat pipe and a lower heat pipe of the expandable heat exchanger, and wherein the plurality of mesh fins are expanded or compressed in response to a movement of the upper heat pipe or the lower heat pipe, or both.

14. The computing device of claim 9, wherein the expandable heat exchanger comprises a honeycomb material coupled to an upper heat pipe and a lower heat pipe of the expandable heat exchanger, and wherein the honeycomb material is expanded or compressed in response to a movement of the upper heat pipe or the lower heat pipe, or both.

15. The computing device of claim 9, wherein the expandable heat exchanger comprises a plurality of expandable cups coupled to an upper heat pipe and a lower heat pipe of the expandable heat exchanger, and wherein the plurality of expandable cups are expanded or compressed in response to a movement of the upper heat pipe or the lower heat pipe, or both.

16. The computing device of claim 1, wherein the expandable component comprises an expandable fan that is configured to expand by increasing a size of a plurality of blades of the expandable fan.

17. The computing device of claim 16, wherein the plurality of blades comprises a plurality of nested blades.

18. The computing device of claim 16, wherein the plurality of blades comprises a plurality of elastic blades.

19. The computing device of claim 16, wherein the plurality of blades comprises a plurality of hinged blades.

20. The computing device of claim 1, wherein the expandable component comprises an expandable keyboard.

21. The computing device of claim 1, wherein the expandable component comprises an expandable pointing device.

22. The computing device of claim 1, wherein the logic is to determine the desired performance range for the computing device in response to input from a user of the computing device.

23. The computing device of claim 1, wherein the logic is to determine the desired performance range for the computing device automatically based on operating conditions of the computing device.

24. The computing device of claim 1, wherein the logic is to:
determine a cooling capacity for the computing device that corresponds to the desired performance range; and
expand or compress the expandable component to provide the determined cooling capacity for the computing device.

25. The computing device of claim 1, wherein the logic is to:
determine a geometry of the expandable component that will provide the desired performance range for the computing device; and
expand or compress the expandable component to achieve the determined geometry.

26. At least one machine readable medium having instructions stored therein that, in response to being executed on a computing device, cause the computing device to:
determine a desired performance range for the computing device; and
expand or compress an expandable component of the computing device to achieve the desired performance range.

27. The at least one machine readable medium of claim 26, wherein the instructions cause the computing device to:
determine a cooling capacity for the computing device that corresponds to the desired performance range; and
expand or compress the expandable component to provide the determined cooling capacity for the computing device.

28. The at least one machine readable medium of claim 26, wherein the instructions cause the computing device to:
determine a geometry of the expandable component that will provide the desired performance range for the computing device; and
expand or compress the expandable component to achieve the determined geometry.

29. The at least one machine readable medium of claim 26, wherein the instructions cause the computing device to determine the desired performance range for the computing device in response to input from a user of the computing device.

30. The at least one machine readable medium of claim 26, wherein the instructions cause the computing device to determine the desired performance range for the computing device automatically based on operating conditions of the computing device.
